(19) United States
(12) Patent Application Publication
(10) Pub. No.: US 2022/0400316 A1
(43) Pub. Date: Dec. 15, 2022

(54) PERSONAL PROGRAM AND CHANNEL GUIDE DATABASE

(71) Applicant: Sony Group Corporation, Tokyo (JP)

(72) Inventor: Jenke Wu Kuo, San Diego, CA (US)

(73) Assignee: Sony Group Corporation, Tokyo (JP)

(21) Appl. No.: 17/344,725

(22) Filed: Jun. 10, 2021

(51) Int. Cl. H04N 21/482; H04N 21/433; G06F 16/438

(52) U.S. Cl. CPC H04N 21/4825; H04N 21/4332; H04N 21/4821; G06F 16/4387

(57) ABSTRACT

Embodiments generally relate to providing a personalized program and channel guide database. In some embodiments, a method includes receiving a personalized database request from a user. The method further includes obtaining one or more playlists from one or more corresponding content providers. The method further includes generating a personalized database for the user, where the personalized database includes the one or more playlists.

### BACKGROUND

Conventional electronic programming guides (EPGs) are formed by individual broadcasters or service providers. EPGs are downloaded to a dedicated media device to show guide and channel information on a user interface (UI). The end user or subscriber can only select the media content through a EPG provided by the service provider of the particular media content. Typically, the end user can access EPGs of other service providers, but the user needs to navigate to the UIs of those service providers. Navigating between different EPGs of different services providers can be awkward and time consuming.

### SUMMARY

Embodiments generally relate to providing a personalized program and channel guide database. In some embodiments, a system includes one or more processors, and includes logic encoded in one or more non-transitory computer-readable storage media for execution by the one or more processors. When executed, the logic is operable to cause the one or more processors to perform operations including: receiving a personalized database request from a user; obtaining one or more playlists from one or more corresponding content providers; and generating a personalized database for the user, where the personalized database includes the one or more playlists.

With further regard to the system, in some embodiments, the one or more playlists include television programs. In some embodiments, the one or more playlists include music. In some embodiments, the logic when executed is further operable to cause the one or more processors to perform operations including obtaining the one or more playlists based on scraping. In some embodiments, the logic when executed is further operable to cause the one or more processors to perform operations including filtering media content items that are not playable on a target player device. In some embodiments, the logic when executed is further operable to cause the one or more processors to perform operations including: providing a user interface (UI); and enabling the user to access the one or more playlists from the UI. In some embodiments, the logic when executed is further operable to cause the one or more processors to perform operations including displaying the personalized database based on one or more user preferences.

In some embodiments, a non-transitory computer-readable storage medium with program instructions thereon is provided. When executed by one or more processors, the instructions are operable to cause the one or more processors to perform operations including: receiving a personalized database request from a user; obtaining one or more playlists from one or more corresponding content providers; and generating a personalized database for the user, where the personalized database includes the one or more playlists.

With further regard to the computer-readable storage medium, in some embodiments, the one or more playlists include television programs. In some embodiments, the one or more playlists include music. In some embodiments, the instructions when executed are further operable to cause the one or more processors to perform operations including obtaining the one or more playlists based on scraping. In some embodiments, the instructions when executed are further operable to cause the one or more processors to perform operations including filtering media content items that are not playable on a target player device. In some embodiments, the instructions when executed are further operable to cause the one or more processors to perform operations including: providing a user interface (UI); and enabling the user to access the one or more playlists from the UI. In some embodiments, the instructions when executed are further operable to cause the one or more processors to perform operations including displaying the personalized database based on one or more user preferences.

In some embodiments, a method includes: receiving a personalized database request from a user; obtaining one or more playlists from one or more corresponding content providers; and generating a personalized database for the user, where the personalized database includes the one or more playlists.

With further regard to the method, in some embodiments, the one or more playlists include television programs. In some embodiments, the one or more playlists include music. In some embodiments, the method further includes obtaining the one or more playlists based on scraping. In some embodiments, the method further includes filtering media content items that are not playable on a target player device. In some embodiments, the method further includes providing a user interface (UI) and enabling the user to access the one or more playlists from the UI. In some embodiments, the method further includes displaying the personalized database based on one or more user preferences.

A further understanding of the nature and the advantages of particular embodiments disclosed herein may be realized by reference of the remaining portions of the specification and the attached drawings.

### BRIEF DESCRIPTION OF THE DRAWINGS

FIG. 1 is a block diagram of an example environment for providing a personalized program and channel guide database, which may be used for some embodiments described herein.

FIG. 2 is an example flow diagram for providing a personalized program and channel guide database, according to some embodiments.

FIG. 3 is a diagram of an example user interface for providing a personalized program and channel guide database, according to some embodiments.

FIG. 4 is a block diagram of an example network environment, which may be used for some embodiments described herein.

FIG. 5 is a block diagram of an example computer system, which may be used for some embodiments described herein.

### DETAILED DESCRIPTION

Embodiments described herein generally relate to providing a personalized program and channel guide database. In some embodiments, a system receives a personalized database request from a user. The system obtains one or more playlists from one or more corresponding content providers. The system further generates a personalized database for the user, where the personalized database includes the one or more playlists.

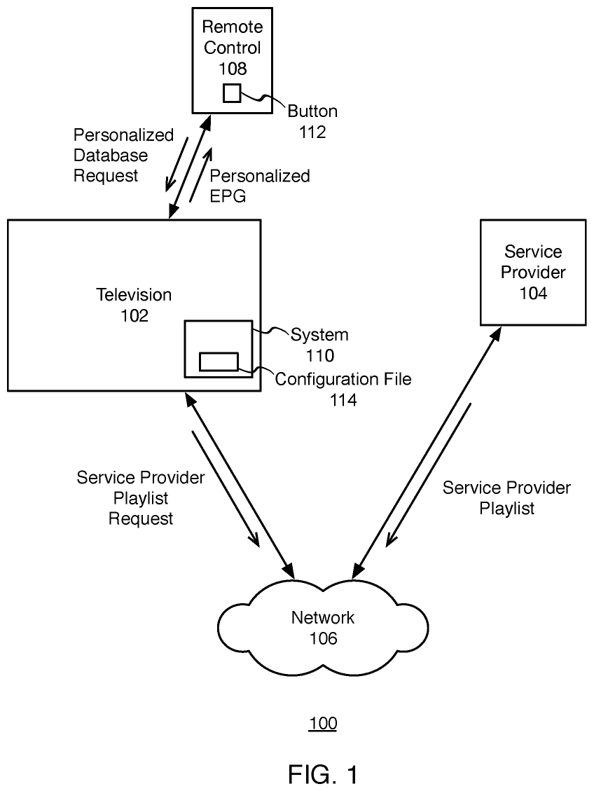

FIG. 1 is a block diagram of an example media environment 100 for providing a personalized program and channel guide database, which may be used for some embodiments described herein. In some implementations, media environment 100 includes a television platform, e.g., standalone television 102 and a service provider 104, which may communicate with each other via a network 106. In some implementations, the network may be the Internet. In some implementations, the network may include any combination of networks such as the Internet, a wide area network (WAN), a local area network (LAN), a Wi-Fi network, a Bluetooth network, near-field communication (NFC) network, cable network, etc.

In various implementations, a user may use a remote control 108 to communicate with a system 110 associated with television 102. In various embodiments, remote control 108 may be a client device such as a smart phone, tablet, wearable device, computer, etc. The terms remote control, remote control device, remote, and client device may be used interchangeably. Remote control 108 includes various control buttons such as button 112. For ease of illustration, one button 112 is shown. There may be any number of control buttons on remote control 108. The remote control 108 is shown in this particular example. In other embodiments, there may be an on-screen menu of icons selected by highlighting and selecting, or on-screen menu of icons that are selected via a touch-screen interface.

In various implementations, the user requests a personalized database. System 110 then accesses one or more playlists from one or more service providers, which in turn provide one or more respective playlists. System 110 provides the user with a personalized program and channel guide database, which in turn provides a user with a personalized electronic programming guide (EPG).

Such a personalized EPG enables the user to access a variety of media features, services, and products provided by different service providers. Further example embodiments are described in more detail herein.

In various implementations, system 110 may communicate with service provider 104 on behalf of television 102 in order to access an EPG dedicated to service provider 104 or to access a list of available products and services from service provider 104. Such programs and services may include television programs, television features, applications, and any other products and services provided by service provider 104.

In some implementations, system 110 may be integrated with television 102, and may control television 102. In some alternative implementations, system 110 may also be separate from television 102, e.g., in a set-top box or an HDMI dongle, and still control what gets displayed on the television 102. In some implementations, system 110 may be integrated with a computer system that is separate from television 102. In some implementations, system 110 may be integrated with a server device in the cloud.

In various implementations, button 112 is associated with configuration file 114 that is accessible by system 110. In this particular example implementation, configuration file 114 is stored at system 110. In some embodiments, configuration file 114 may be stored remotely from system 110 and may be accessible by system 110. A configuration file is not required, but may provide added configurability.

For ease of illustration, FIG. 1 shows one block for each of television 102, service provider 104, network 106, system 110, and configuration file 114. These blocks 102-104 may represent multiple televisions, service providers, networks, systems, and configuration files. Also, there may be any number of client devices. In other embodiments, environment 100 may not have all of the components shown and/or may have other elements including other types of elements instead of, or in addition to, those shown herein.

While system 110 performs embodiments described herein, in other embodiments, any suitable component or combination of components associated with system 110 or any suitable processor or processors associated with system 110 may facilitate performing the embodiments described herein.

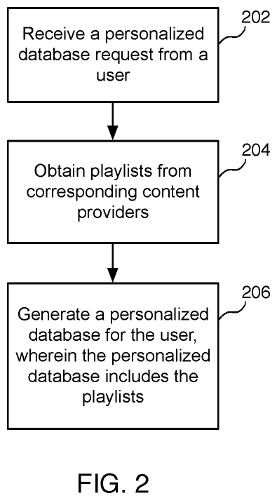

FIG. 2 is an example flow diagram for providing a personalized program and channel guide database, according to some embodiments. Referring to both FIGS. 1 and 2, a method is initiated at block 202, where a system such as system 102 receives a personalized database request from a user. In some embodiments, in the request, the user may request that the system scan or collect program and channel guide databases associated with a subscribed broadcast and/or broadband services to form a personnel program and channel guide database in one entity.

At block 204, the system obtains one or more playlists from one or more corresponding content providers. In various embodiments, one or more playlists may include media items such as television programs. In various embodiments, one or more playlists may include media items such as music. The particular types of media items listed in the playlists may vary and the particular types will depend on the particular implementation. For example, in some embodiments, one or more playlists may include media items such as subscription podcasts (e.g., podcasts from a particular media store such as Apple Store™, or other Internet sources, etc.), live streams (e.g., live streams from particular social media, or other Internet sources, etc.).

In some embodiments, the system may also obtain media data for each media item on the playlists. For example, such media data may include a schedule (e.g., days, times, etc.) with one or more times for watching or listening to a particular media item. The particular media data my vary depending on the implementation. For example, in some embodiments, media data may include the source (e.g., service provider, etc.) of each media item, cost information if applicable (e.g., price per viewing, subscription information, etc.).

In various embodiments, the system may store such media data (e.g., schedule, source, etc.) in the personalized database and may provide some of the media data in a personalized RPG. Such media data informs the user as to what media items the user wants to include in the user's personalized RPG. If presented in the personalized RPG, the media items enable the to select particular items in the personalized RPG to watch or listen to.

In various embodiments, the system obtains the one or more playlists based on data scraping. In various embodiments, data scraping may be defined as a technique where the system extracts data from the website of a service provider. The system may access the playlists via the uniform resource locator (URL) of each service provider. In various embodiments, the system filters media content items that are not playable on a target player device.

At block 206, the system generates a personalized database for the user, where the personalized database includes the one or more playlists. In some embodiments, the user may also add one or more playlists from the Internet into the personalized channel and program guide database. The personalized channel and program guide database may also be referred to as a personalized database. The system may generate from the personalized database a personalized EPG. In some embodiments, the personalized EPG may have user-selected channels with various user-selected programs. Programs may also include user-preferred programs collected in the personalized database. The user may view streaming content from the service provider yet using the personalized database and personalized EPG.

In various embodiments, the system provides a user interface (UI). As described in more detail herein, the system enables the user to access the one or more playlists from the UI. In various embodiments, the playlists may be associated with separate and independent service providers. The system aggregates the different playlists in the personalized database. The system displays the personalized database based on one or more user preferences. As a result, the user may access products and services from different service providers using the personalized database and personalized EPG.

In various embodiments, the user may create their own playlist/private channel seamlessly across broadcast broadband media services and local media services. The user may add, subscribe, switch, and update the personalized EPG. The user may categorize, sort, show, or hide programs/channels as per personal preference. The user may also cast or tune the streaming to another media device to play the content. The personal program and channel guide database can be stored in any cloud service or local devices.

Although the steps, operations, or computations may be presented in a specific order, the order may be changed in particular embodiments. Other orderings of the steps are possible, depending on the particular embodiment. In some particular embodiments, multiple steps shown as sequential in this specification may be performed at the same time. Also, some embodiments may not have all of the steps shown and/or may have other steps instead of, or in addition to, those shown herein.

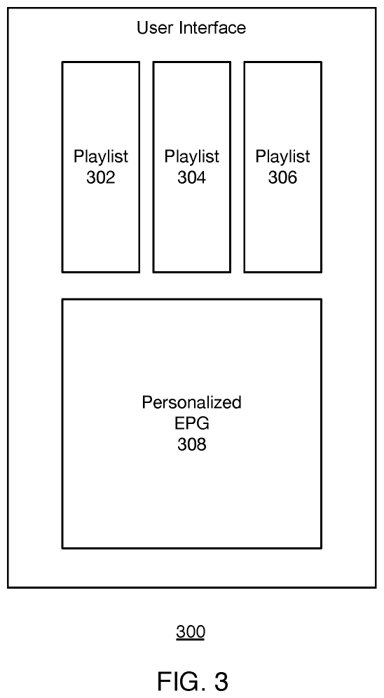

In various embodiments, the system provides a user interface (UI). As indicated herein, the system then enables the user to access the one or more playlists from the UI. Example embodiments directed to the UI are described in more detail below in connection with FIG. 3.

FIG. 3 is a diagram of an example user interface 300 for providing a personalized program and channel guide database, according to some embodiments. User interface 300 may be displayed on a display of a client device such as remote control 108 of FIG. 1 or other client devices.

As shown, user interface 300 displays one or more playlists 302, 304, and 306. As indicated herein, each playlist 302, 304, and 306 may include media items including media programs and services. For example, media programs may include television programs, movies, news, music, etc. In some embodiments, the playlists 302, 304, and 306 may be from one or more different service providers, where the system aggregates the media items into a single personalized database view from media items from playlists 302, 304, and 306.

In some embodiments, the system may generate multiple views. For example, one view may include upcoming newly-released media items (e.g., podcasts, television episodes, movies, etc.) by date and time. Another example view may include genre indications (e.g., science fiction, talks, documentaries, etc.). Another example view may include time-bound media items (e.g., 2020 favorites, etc.).

In various embodiments, the system provides the user with a personalized EPG 308. The system enables the user to build personalized EPG using media items from playlists 302, 304, and 306.

The personalized EPG enables the user to enjoy watching media content with the user's own channels seamlessly in a single personalized program guide. The user may tune to a channel of broadcast services, streaming of IP media services, etc. from various different service providers.

In various embodiments, the system enables the user to send personalized EPGs 308 to other client devices or media devices (e.g., smart TV, etc.) to access media items from the personalized database. The user may upload a personalized database in the cloud to share among media devices to play the program contents/media items. In various embodiments, the system may determine if a given media device cannot play a particular media item. In such scenarios, the system may filter out media items that cannot be played and may find an alternative program to play. For example, a mobile device might not have a tuner for broadcast services. In some embodiments, the system may use an agent or artificial intelligence (AI) to search for a version of a particular media item that is compatible by a given mobile device.

Embodiments described herein provide various benefits. For example, embodiments enable a user to access media items from multiple different service providers via a single personalized database and personalized EPG.

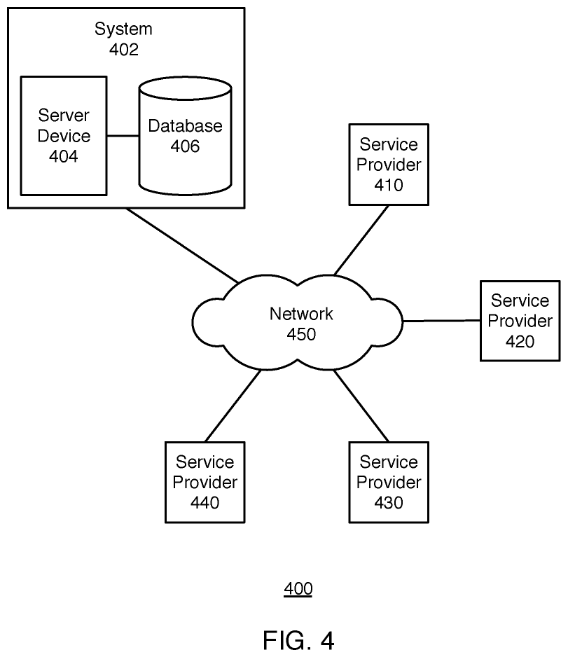

FIG. 4 is a block diagram of an example network environment 400, which may be used for some embodiments described herein. In some embodiments, network environment 400 includes a system 402, which includes a server device 404 and a database 406. For example, system 402 may be used to implement system 102 of FIG. 1, as well as to perform embodiments described herein. Network environment 400 also includes client devices 410, 420, 430, and 440, which may communicate with system 402 and/or may communicate with each other directly or via system 402. Network environment 400 also includes a network 450 through which system 402 and client devices 410, 420, 430, and 440 communicate. Network 450 may be any suitable communication network such as a Wi-Fi network, Bluetooth network, the Internet, etc.

For ease of illustration, FIG. 4 shows one block for each of system 402, server device 404, and network database 406, and shows four blocks for client devices 410, 420, 430, and 440. Blocks 402, 404, and 406 may represent multiple systems, server devices, and network databases. Also, there may be any number of client devices. In other embodiments, environment 400 may not have all of the components shown and/or may have other elements including other types of elements instead of, or in addition to, those shown herein.

While server device 404 of system 402 performs embodiments described herein, in other embodiments, any suitable component or combination of components associated with system 402 or any suitable processor or processors associated with system 402 may facilitate performing the embodiments described herein.

In the various embodiments described herein, a processor of system 402 and/or a processor of any client device 410, 420, 430, and 440 cause the elements described herein (e.g., information, etc.) to be displayed in a user interface on one or more display screens.

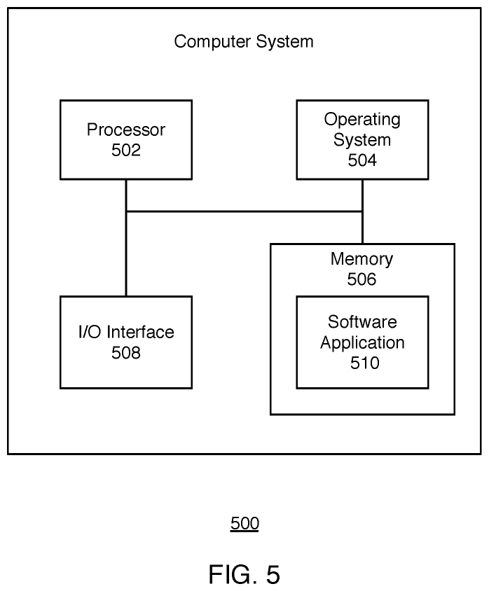

FIG. 5 is a block diagram of an example computer system 500, which may be used for some embodiments described herein. For example, computer system 500 may be used to implement server device 404 of FIG. 4 and/or system 102 of FIG. 1, as well as to perform embodiments described herein. In some embodiments, computer system 500 may include a processor 502, an operating system 504, a memory 506, and an input/output (I/O) interface 508. In various embodiments, processor 502 may be used to implement various functions and features described herein, as well as to perform the method embodiments described herein. While processor 502 is described as performing embodiments described herein, any suitable component or combination of components of computer system 500 or any suitable processor or processors associated with computer system 500 or any suitable system may perform the steps described. Embodiments described herein may be carried out on a user device, on a server, or a combination of both.

Computer system 500 also includes a software application 510, which may be stored on memory 506 or on any other suitable storage location or computer-readable medium. Software application 510 provides instructions that enable processor 502 to perform the embodiments described herein and other functions. Software application may also include an engine such as a network engine for performing various functions associated with one or more networks and network communications. The components of computer system 500 may be implemented by one or more processors or any combination of hardware devices, as well as any combination of hardware, software, firmware, etc.

For ease of illustration, FIG. 5 shows one block for each of processor 502, operating system 504, memory 506, I/O interface 508, and software application 510. These blocks 502, 504, 506, 508, and 510 may represent multiple processors, operating systems, memories, I/O interfaces, and software applications. In various embodiments, computer system 500 may not have all of the components shown and/or may have other elements including other types of components instead of, or in addition to, those shown herein.

Although the description has been described with respect to particular embodiments thereof, these particular embodiments are merely illustrative, and not restrictive. Concepts illustrated in the examples may be applied to other examples and embodiments.

In various embodiments, software is encoded in one or more non-transitory computer-readable media for execution by one or more processors. The software when executed by one or more processors is operable to perform the embodiments described herein and other functions.

Any suitable programming language can be used to implement the routines of particular embodiments including C, C++, C#, Java, JavaScript, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a non-transitory computer-readable storage medium (also referred to as a machine-readable storage medium) for use by or in connection with the instruction execution system, apparatus, or device. Particular embodiments can be implemented in the form of control logic in software or hardware or a combination of both. The control logic when executed by one or more processors is operable to perform the embodiments described herein and other functions. For example, a tangible medium such as a hardware storage device can be used to store the control logic, which can include executable instructions.

Particular embodiments may be implemented by using a programmable general purpose digital computer, and/or by using application specific integrated circuits, programmable logic devices, field programmable gate arrays, optical, chemical, biological, quantum or nanoengineered systems, components and mechanisms. In general, the functions of particular embodiments can be achieved by any means as is known in the art. Distributed, networked systems, components, and/or circuits can be used. Communication, or transfer, of data may be wired, wireless, or by any other means.

A “processor” may include any suitable hardware and/or software system, mechanism, or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable data storage, memory and/or non-transitory computer-readable storage medium, including electronic storage devices such as random-access memory (RAM), read-only memory (ROM), magnetic storage device (hard disk drive or the like), flash, optical storage device (CD, DVD or the like), magnetic or optical disk, or other tangible media suitable for storing instructions (e.g., program or software instructions) for execution by the processor. For example, a tangible medium such as a hardware storage device can be used to store the control logic, which can include executable instructions. The instructions can also be contained in, and provided as, an electronic signal, for example in the form of software as a service (SaaS) delivered from a server (e.g., a distributed system and/or a cloud computing system).

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

1. A system comprising:
one or more processors; and
logic encoded in one or more non-transitory computer-readable storage media for execution by the one or more processors and when executed operable to cause the one or more processors to perform operations comprising:
receiving a personalized database request from a user;
obtaining one or more playlists from each content provider of a plurality of content providers;
generating a personalized database for the user;
aggregating the one or more playlists obtained from the plurality of content providers in the personalized database, wherein the one or more playlists are associated with separate and independent service providers of the plurality of content providers;
enabling the user to send one or more personalized electronic program guides to other client devices to access media items from the personalized database;
determining if a target player device cannot play a particular media item of the media items; and
finding an alternative version of the particular media item that is compatible with the target player device.

2. The system of claim 1, wherein the one or more playlists comprise television programs.

3. The system of claim 1, wherein the one or more playlists comprise music.

4. The system of claim 1, wherein the logic when executed is further operable to cause the one or more processors to perform operations comprising obtaining the one or more playlists based on scraping.

5. The system of claim 1, wherein the logic when executed is further operable to cause the one or more processors to perform operations comprising filtering media content items that are not playable on a target player device.

6. The system of claim 1, wherein the logic when executed is further operable to cause the one or more processors to perform operations comprising:
providing a user interface (UI); and
enabling the user to access the one or more playlists from the UI.

7. The system of claim 1, wherein the logic when executed is further operable to cause the one or more processors to perform operations comprising displaying the personalized database based on one or more user preferences.

8. A non-transitory computer-readable storage medium with program instructions stored thereon, the program instructions when executed by one or more processors are operable to cause the one or more processors to perform operations comprising:
receiving a personalized database request from a user;
obtaining one or more playlists from each content provider of a plurality of content providers;
generating a personalized database for the user;
aggregating the one or more playlists obtained from the plurality of content providers in the personalized database, wherein the one or more playlists are associated with separate and independent service providers of the plurality of content providers;
enabling the user to send one or more personalized electronic program guides to other client devices to access media items from the personalized database;
determining if a target player device cannot play a particular media item of the media items; and
finding an alternative version of the particular media item that is compatible with the target player device.

9. The non-transitory computer-readable storage medium of claim 8, wherein the one or more playlists comprise television programs.

10. The non-transitory computer-readable storage medium of claim 8, wherein the one or more playlists comprise music.

11. The non-transitory computer-readable storage medium of claim 8, wherein the instructions when executed are further operable to cause the one or more processors to perform operations comprising obtaining the one or more playlists based on scraping.

12. The non-transitory computer-readable storage medium of claim 8, wherein the instructions when executed are further operable to cause the one or more processors to perform operations comprising filtering media content items that are not playable on a target player device.

13. The non-transitory computer-readable storage medium of claim 8, wherein the instructions when executed are further operable to cause the one or more processors to perform operations comprising:
providing a user interface (UI); and
enabling the user to access the one or more playlists from the UI.

14. The non-transitory computer-readable storage medium of claim 8, wherein the instructions when executed are further operable to cause the one or more processors to perform operations comprising displaying the personalized database based on one or more user preferences.

15. A computer-implemented method comprising:
receiving a personalized database request from a user;
obtaining one or more playlists from each content provider of a plurality of content providers;
generating a personalized database for the user;
aggregating the one or more playlists obtained from the plurality of content providers in the personalized database, wherein the one or more playlists are associated with separate and independent service providers of the plurality of content providers;
enabling the user to send one or more personalized electronic program guides to other client devices to access media items from the personalized database;
determining if a target player device cannot play a particular media item of the media items; and
finding an alternative version of the particular media item that is compatible with the target player device.

16. The method of claim 15, wherein the one or more playlists comprise television programs.

17. The method of claim 15, wherein the one or more playlists comprise music.

18. The method of claim 15, further comprising obtaining the one or more playlists based on scraping.

19. The method of claim 15, further comprising filtering media content items that are not playable on a target player device.

20. The method of claim 15, further comprising:
providing a user interface (UI); and
enabling the user to access the one or more playlists from the UI.
